(19) United States
(12) Patent Application Publication
(10) Pub. No.: US 2018/0238571 A1
(43) Pub. Date: Aug. 23, 2018

(54) VENTILATION SYSTEM

(71) Applicant: XTRALIS GLOBAL, Dublin (IE)

(72) Inventor: Steve William JOSEPH, Portland, OR (US)

(21) Appl. No.: 15/574,048

(22) PCT Filed: May 6, 2016
(86) PCT No.: PCT/EP2016/060194

§ 371 Date: Nov. 14, 2017

Related U.S. Application Data
(60) Provisional application No. 62/167,212, filed on May 27, 2015.

(51) Int. Cl. F24F 11/00; G01N 1/22

(52) U.S. Cl. CPC F24F 11/0001; F24F 2007/003; G01N 1/2273; G01N 1/2205

(57) ABSTRACT

The present invention relates to a ventilation system that may advantageously be used in enclosed or confined spaces. The illustrated embodiment is a ventilation system with one or more sensors arranged to analyse either or both the air received into a ventilation chamber and a remote air sample that is drawn through an air sampling system, e.g., via an auxiliary air sampling port.

### FIELD OF THE INVENTION

The present invention relates to a ventilation system, e.g. for use in enclosed or confined spaces.

### BACKGROUND OF THE INVENTION

Ventilation systems are generally used to maintain acceptable indoor air quality. For example, such systems are used to control temperature, replenish oxygen or remove moisture, odours, smoke, dust and other particles.

Air ventilation is required for enclosed spaces in which electrical equipment is housed and operated. The operation of electrical equipment generates heat and requires additional cooling. There are also requirements for monitoring environmental conditions, such as temperature, humidity and the presence of particles. In particular, there is a need for smoke detection due to the risk of fires caused by electrical faults. There may also be requirements for monitoring hydrogen gas levels in battery rooms. Thus operating electrical equipment in these enclosed spaces can involve multiple sensing devices, in addition to ventilation systems. This can increase operational costs due to managing separate systems, including the need to supervise and control each respective operation, and to ensure co-operability between systems.

Accordingly it is an object of the present invention to ameliorate or address one or more of the above problems with the prior art, or at least provide a useful alternative to them.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In one form the present invention relates to a ventilation system for moving air from one side of a wall to another, the system including: a housing for installation having a ventilation chamber with at least one ventilation inlet to receive air from a first side of the wall and at least one ventilation outlet to expel air to a second side the wall; an exhaust fan installed in the ventilation chamber, the exhaust fan operable to draw in air from an environment immediately surrounding the at least one ventilation inlet, and to expel air from the ventilation chamber through the at least one ventilation outlet; at least one auxiliary air sampling port adapted for connection to an air sampling duct through which a remote air sample can be drawn from an environment immediately surrounding the air sampling duct, but remote from the housing; and one or more sensor devices arranged to be exposed to air received through the at least one the ventilation inlet and the at least one auxiliary air sampling port, for sensing at least one environmental condition.

The remote air sample can be drawn through the at least one auxiliary air sampling port by operation of the exhaust fan.

The system can include at least one ventilation air sampling port through which air from the ventilation chamber can be drawn to the one or more sensor devices by operation of the exhaust fan.

The system can include at least one detection chamber for housing the one or more sensor devices in which the air is analysed. In some embodiments, a common detection chamber may be provided for housing the one or more sensor devices.

The detection chamber can include at least one exhaust port for connection to a ventilation duct through which the analysed air is transferred from the at least one detection chamber to the ventilation chamber.

Preferably, the one or more sensor devices analyse a proportion of the remote air sample. The air sampling duct can be arranged such that air bypasses the at least one auxiliary air sampling port and is drawn into the ventilation chamber.

Preferably, the ventilation system is configured to provide a first airflow through the at least one ventilation inlet that is greater than a second airflow through the air sampling duct. In some embodiments, a ratio of the first airflow to the second airflow is 4:1, although other ratios can be used.

Preferably, the sensor device is configured to sense one or more environmental conditions, including but not limited to: smoke, gas, dust temperature or humidity.

The ventilation system can also include a control system. The control system can be configured to control of the operation of the ventilation system in response to sensed environmental conditions.

The ventilation system can also include a communications subsystem for reporting to an external system any one or more of: an environmental conditions sensed by the one or more sensor devices; an operating status of the exhaust fan.

The sensor device can include means to block at least one of the ventilation air sampling port or the remote air sampling port to prevent the drawing of air through the blocked port.

The sensor device can include a filter placed at a point between the detection chamber and one or more of the sampling ports for filtering unwanted particles from the air sample prior to analysis.

Preferably, the ventilation system includes a flow impedance that determines what proportion of the air sample is drawn as a local air sample or a remote air sample. The flow impedance may be provided by an opening which has a predetermined flow resistance or a filter element having a predetermined flow resistance.

### BRIEF DESCRIPTION OF THE DRAWINGS

Preferred embodiments of the present invention will now be described, by way of non-limiting example only, with reference to the accompanying drawings, in which:

FIG. 1 is a schematic illustration of a ventilation system according to an embodiment of the present invention;

FIG. 2 illustrates a front of an outer cover of the ventilation system of FIG. 1;

FIG. 3 illustrates a cross sectional view through the ventilation system of FIG. 2;

FIG. 4 illustrates a schematic illustration of air paths used in the ventilation system of FIG. 1.

### DETAILED DESCRIPTION OF THE EMBODIMENTS

The preferred form of the invention provides a ventilation system with one or more sensors arranged to analyse either or both the air received into a ventilation chamber and a remote air sample.

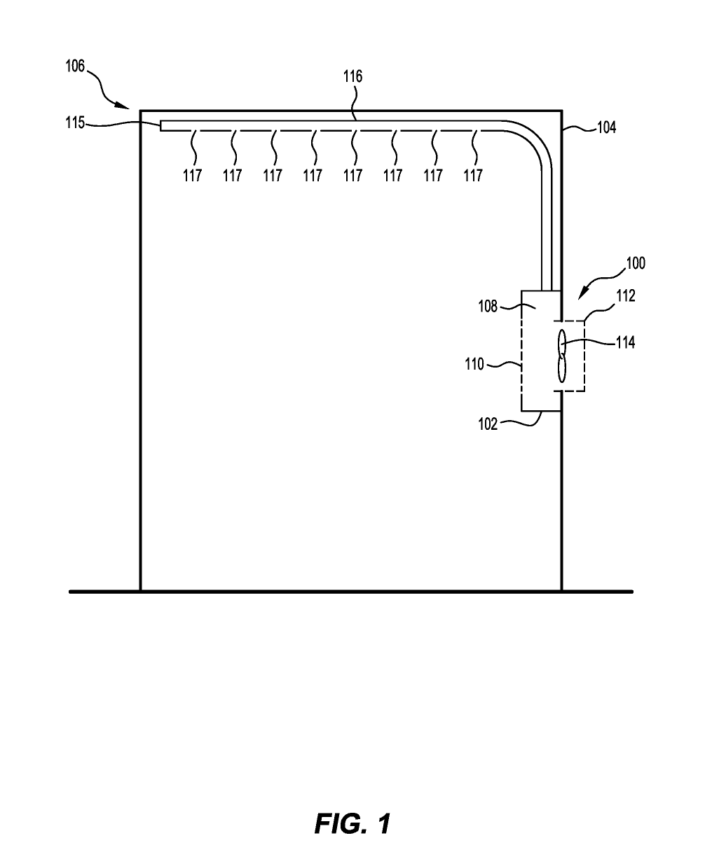

FIG. 1 is a schematic illustration of a ventilation system according to an embodiment of the present invention. The ventilation system 100 includes a main housing 102. Preferably the housing is sealed, e.g. to IP65 standard or other appropriate standard for its installation situation.

The housing 102 is installed, for example, in a wall 104 of an enclosed space 106. The housing 102 includes a ventilation chamber 108 with at least one ventilation inlet 110 to receive air from a first side of the wall and at least one ventilation outlet 112 to expel air to a second side the wall. An exhaust fan 114 is installed in the ventilation chamber 108. The exhaust fan 114 operates to draw air from the environment immediately surrounding the ventilation inlet 110 into the ventilation chamber 108, and expels air from the ventilation chamber 108 through the ventilation outlet 112. Accordingly, the exhaust fan 114 provides a ventilation path from one side of the wall 104 to another i.e. ventilating air from the interior to the exterior of the enclosed space 106. An air sampling duct 116 e.g. a pipe (or series of interconnected pipes), which could have either an open end 115 or one or more sampling points 117 spaced along it, can be connected to the housing 102 to allow air to be drawn from an environment surrounding the air sampling duct 116. This environment is preferably remote from the housing 102.

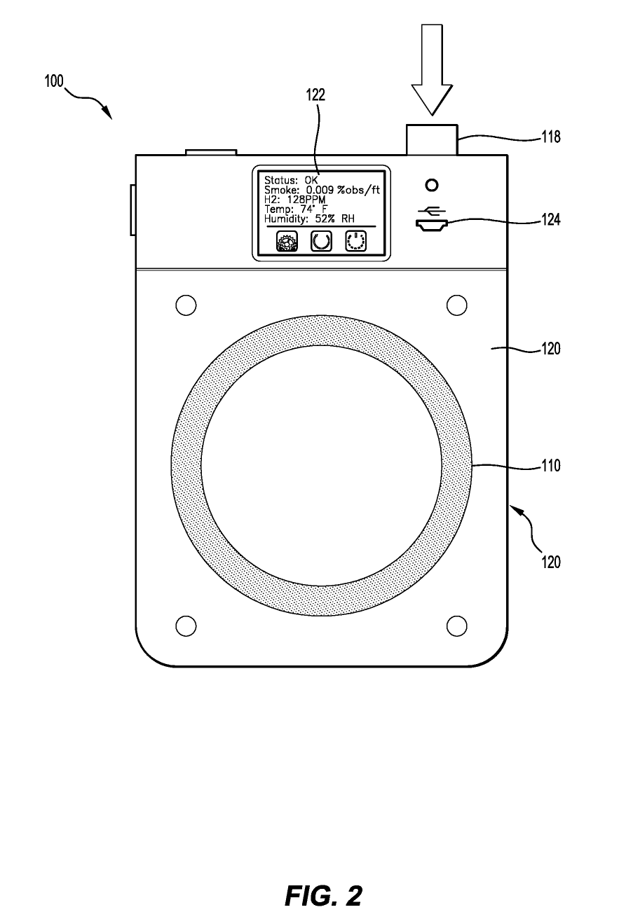

As described in detail herein with references to FIGS. 2 to 4, the ventilation system 100 includes one or more sensor devices capable of monitoring environmental conditions including but not limited to: smoke, gas, dust, temperature and humidity inside or the enclosed space 106. The sensors are arranged to be exposed to air received through the ventilation inlet 110 and the air sampling duct 116.

The ventilation system 100 can also include a control system 119 within the housing 102, e.g. a microprocessor programmed to control the operation of the system. The control system is configured to respond to sensed environmental conditions. The control system may trigger an alarm, or notification and/or control the operation of the exhaust fan 114. For example, if the detected temperature exceeds a particular level, the control system can respond by increasing the speed of the exhaust fan 114 to provide additional cooling. Similarly if a high level of an explosive e.g. hydrogen gas, or other dangerous gas, is detected the exhaust fan speed can be increased to evacuate the area and reduce the danger. Alternatively the fan can be shut down or slowed if the sensed condition dictates that minimising air flow is desirable. As will be appreciated the control system can also include a memory for storing software instructions, event logs, and other data as will be known to those skilled in the art.

Adjusting fan speeds in response to detected environmental conditions can additionally allow for energy savings and longevity of the fan operation. The exhaust fan 114 can generally operate at lower speeds for energy savings, and speed up to expedite extraction in response to an alarm response by the controller. After the detected environmental conditions return to acceptable or standard levels, the fan speed can return to the default lower speed.

The ventilation system 100 can also include a communications subsystem 121 for reporting information to an external system, such as a centralised control for the enclosed space 106, such as a fire alarm panel, central control room, building management system or the like. Reporting can be via relay output that indicates conditions such as (fire, action, fault) or other conditions. Communication can also take place via Bluetooth, Ethernet, GPI or SNMP or other known interface or proprietary network or protocol.

For example, the ventilation system 100 can report environmental conditions sensed by sensor devices (i.e. particle levels, humidity levels and/or temperature). Additionally, the ventilation system 100 can report the operating status of the exhaust fan 114 such as current operating speeds in order to meet required environmental codes or standards, or whether the exhaust fan 114 is functioning. The operation of the exhaust fan 114 may be monitored using a range of known mechanisms, including using a tachometer, a magnet and a hall effect sensor, optical sensing, monitoring current draw or other electrical property of the fan motor, to name a few.

The system can also include additional system supervision, such as any one or more of:
a flow monitor to sense flow speed or volume in the airflow path using any known means such as an anemometer, thermal or ultrasonic flow sensor;
Sensor integrity checking to ensure correct operation of the sensor system(s);
Fan operation;
Component or total system power draw.

If abnormal conditions are detected a fault or other reporting signal can be communicated using the communications subsystem.

The example of FIG. 1 is particularly suited for use in telecommunications equipment buildings, where batteries are used as part of an uninterrupted power supply (UPS) and hydrogen gas may therefore be found, because the air sampling duct 116 extends upwards towards the roof and the sampling points spaced along it will therefore be raised to sense an accumulation of lighter-than-air gas near the roof. The reverse arrangement with ground-ward projecting air sampling duct can be used where a heavier-than-air gas is to be sensed.

In the present example, the system is designed for use in a relatively small area, say less than 50 m2 and the ventilation fan 114 is arranged to move between 25 CFM of air in normal operation, but up to 50 CFM when high speed ventilation is needed in response to an adverse condition. The sampling pipe can be up to 10 meters long and include up to 4 sampling points (holes) spaced along its length.

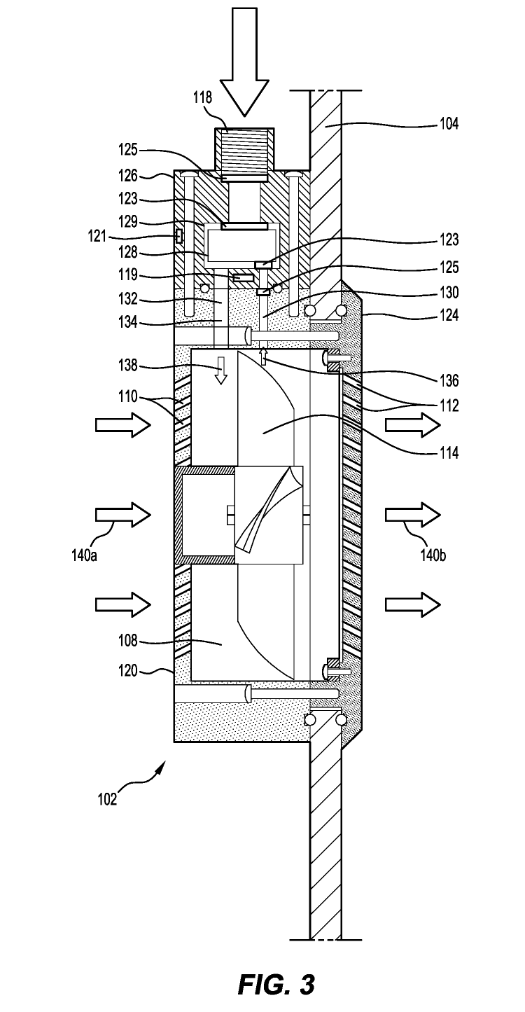

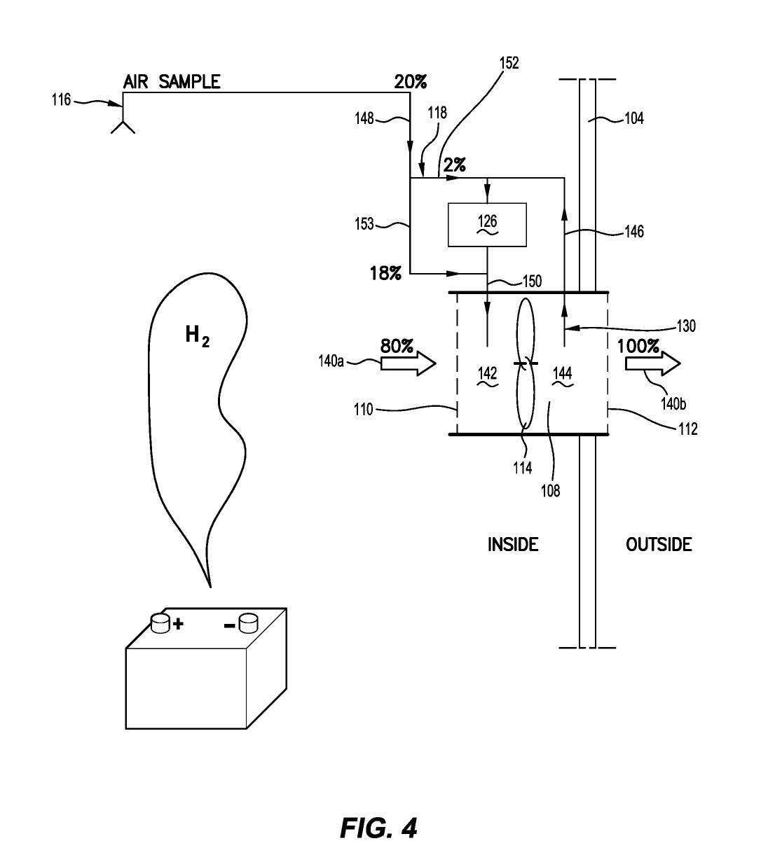

FIG. 2 shows a front view of the ventilation system of FIG. 1. In addition to the elements described above the ventilation system 100 includes:
An auxiliary air sampling port 118 adapted to be connected to the air sampling duct 116. The auxiliary air sampling port 118 delivers air samples drawn in from the air sampling duct 116 and into the sensor(s) in the housing 102, as indicated by the arrow. Air samples may be drawn through the auxiliary air sampling port 118 by operation of the exhaust fan 114 (described herein with reference to FIG. 4).
A front cover 120 of the housing 102 having at least one ventilation inlet 110 (shown as a single a circular opening in FIG. 2 and as plurality of concentric circular openings in FIG. 3). The front cover 120 can also include one or more indicator lights or user interface means such as buttons or switches.
A display 122 (e.g. a LCD or a touch screen display) providing information as to the status of the ventilation system 100 operation and environmental conditions.
A USB port 124, forming part of the communications subsystem, to allow for connection with computer peripherals such as a computer or smartphone for configuration and system diagnostics, or external communications modules, but in which the front cover 120 has a series of openings 110 in circular arrangement.

FIG. 3 illustrates a cross sectional view through the ventilation system of FIG. 2. In addition to the elements described above the ventilation system 100 includes:
A back cover 124 of the housing 102 secured to the second side of the wall 104. The back cover 124 is further secured to the front cover 120. The back cover 124 and the front cover 120 are constructed and securely fixed in order to be tamper resistant. The ventilation outlet 112 is provided as a series of openings in the back cover 124.
A sensor housing 126 can include one or more sensor devices 128. The sensor housing 126 can be secured to the front cover 120. Air from the ventilation chamber 108 can be delivered to the sensor devices 128 through a ventilation air sampling port 130. Air samples may be drawn through the ventilation air sampling port 130 by operation of the exhaust fan 114, indicated by the arrow 136. As previously described, remote air samples can also be drawn into to the detection chamber 129 from the auxiliary air sampling port 118. In this example, the sensor housing 126 provides a common detection chamber in which the sensor(s) can analyse the air samples. In other embodiments, additional detection chambers can be provided to house multiple or respective sensors. The sensor devices 128 can be arranged to sense one or more gases including, Hydrogen, Methane, Propane, Gasoline Vapour, Pentane, Ammonia, Alcohols, Oxygen depletion and/or enrichment, Carbon Monoxide, Hydrogen Sulphide, Sulphur Dioxide, Nitrogen Dioxide, Chlorine or Carbon Dioxide, e.g. using sensors as used in the VESDA ECO system from Xtralis. The sensor can also be a humidity sensor or temperature sensor. Smoke and other particulates can be sensed using any known methods including laser or LED based light scattering or obscuration detection, ionisation detection. Examples of such detector systems are found in VESDA and ICAM particle detectors from Xtralis, although other detection systems are possible.
An exhaust port 132 is provided on the detection chamber 129 for expelling the analysed air samples from the detection chamber. The exhaust port 132 is connected to a ventilation duct 134 through which the analysed air is transferred to the ventilation chamber 108, indicated by the arrow 138. The analysed air is then included in the ventilation path indicated by the arrows 140a and 140b, allowing the analysed air to be subsequently expelled through the ventilation outlet 112.

The sensor device 128 can also include means 123 to block at least one of the ventilation air sampling port 130 or the auxiliary air sampling port 118 to prevent the drawing of air through the blocked port. Such means can simply be a plug, cap, stopper or valve or other device to blank the port, to prevent airflow through it.

In addition to the sensors 128 housed within the sensor housing, additional sensors can be placed on the exterior surfaces of the housing 102. For example, sensors positioned on the exterior surface of the front cover 120 or the back cover 124 can sense environmental conditions outside the housing 102. Accordingly, environmental conditions both inside and outside the housing 102 may be analysed.

Filters 125 can also be positioned at a point between an inlet of one of the sampling ports 118 and 130 and the sensor housing 126 for filtering unwanted particles from the air sample prior to analysis.

FIG. 4 illustrates a schematic illustration of air paths used in the ventilation system of FIG. 1. FIG. 4 includes the elements of the ventilation system 100 as described above.

In use, the exhaust fan 114 provides the ventilation air path generally depicted by the arrows 140a and 140b. The exhaust fan 114 creates a low pressure zone 142 and a high pressure zone 144. The difference in pressure causes air samples to be drawn through the ventilation air sampling port 130 and/or the auxiliary air sampling port 118 to deliver air samples to the sensor housing 126. For example, the air flow from the ventilation chamber 108 through the ventilation air sampling port 130 is shown by the path 146. Similarly, the air from the air sampling duct 116 is shown by the path 148. Air exiting through the exhaust port 132 and ventilation duct 134 to the ventilation chamber 108 is shown by the path 150.

The ventilation system 100 is configured to provide airflow through the ventilation inlet 110 that is greater than airflow through the air sampling duct 116. For example, the ratio of airflow through the ventilation inlet 110 to the airflow through the air sampling duct 116 can be 4:1 (shown as 80%:20% in FIG. 4), although other ratios (without limit) can be used.

For example, the airflow through the ventilation inlet(s) 110 could be 95% and the airflow through the air sampling duct 116 can be 5%. The ventilation system 100 can then expel all the incoming airflow via the ventilation outlet(s) 112.

In this example, the ventilation system is configured such that the air flow 148 from the air sampling duct 116 is proportioned between the remote air sample drawn in through the auxiliary air sampling port 118 (shown as airflow 152) into detection chamber 129, and a remaining portion which bypasses the auxiliary air sampling port 118 and detection chamber 129, and is drawn into the ventilation chamber 108 through the path 153 and 150. For example, the airflow 148 is proportioned 2% and 18% in FIG. 4.

The ventilation system 100 may be provided with a flow impedance that determines what proportion of the air sample is drawn as air from the ventilation air sampling port 130 or through the auxiliary air sampling port 118. The flow impedance may be provided by an opening in the port which has a predetermined flow resistance or a filter element having a predetermined flow resistance.

The sub-sampling arrangement of the flow path 148 could be omitted and instead replaced with a flow path in which the full sample air flow 148 passes through the sensing housing 126 for analysis.

Alternatively, in some embodiments an additional fan or pump could be used to draw in air samples through either or both of the ventilation air sampling port 130 and the auxiliary air sampling port 118, but in this example the low pressure zone cause by the ventilation fan 114 is used to draw air into the sensor housing 126.

In the above examples, the ventilation system 100 is described as being used for venting air from the inside to the outside of an enclosed space. It should therefore be understood that a wall could be any partition separating air spaces from each other, not just an external vertical wall. For example, the ventilation system 100 described herein could be equally used to move air from the exterior to the interior of an enclosed space, from one room to another inside a building, from between a room or cabinet and either an underfloor or above ceiling space or vice versa.

It will be understood that the invention disclosed and defined in this specification extends to all alternative combinations of two or more of the individual features mentioned or evident from the text or drawings. All of these different combinations constitute various alternative aspects of the invention.

1. A ventilation system for moving air from one side of a wall to another, the system including:
a housing for installation having a ventilation chamber with at least one ventilation inlet to receive air from a first side of the wall and at least one ventilation outlet to expel air to a second side the wall;
an exhaust fan installed in the ventilation chamber, the exhaust fan operable to draw in air from an environment immediately surrounding the at least one ventilation inlet, and to expel air from the ventilation chamber through the at least one ventilation outlet;
at least one auxiliary air sampling port adapted for connection to an air sampling duct through which a remote air sample can be drawn from an environment immediately surrounding the air sampling duct, but remote from the housing; and
at least one sensor device arranged to be exposed to air received through the at least one ventilation inlet and the at least one auxiliary air sampling port, for sensing at least one environmental condition.

2. The ventilation system according to claim 1, wherein the remote air sample is drawn through the at least one auxiliary air sampling port by operation of the exhaust fan.

3. The ventilation system according to claim 1, wherein the system includes at least one ventilation air sampling port through which air from the ventilation chamber is drawn to the one or more sensor devices by operation of the exhaust fan.

4. The ventilation system according to claim 1, wherein the system includes at least one detection chamber for housing the one or more sensor devices in which the air is analysed.

5. The ventilation system according to claim 4, wherein the one or more sensor devices are housed in a common detection chamber.

6. The ventilation system according to claim 1, wherein the detection chamber includes at least one exhaust port for connection to a ventilation duct through which the analysed air is transferred from the at least one detection chamber to the ventilation chamber.

7. The ventilation system according to claim 1, wherein the at least one sensor device analyses a proportion of the remote air sample.

8. The ventilation system according to claim 1, wherein the air sampling duct is arranged such that air bypasses the at least one auxiliary air sampling port and is drawn into the ventilation chamber.

9. The ventilation system according to claim 1, wherein the ventilation system is configured to provide a first airflow through the at least one ventilation inlet that is greater than a second airflow through the air sampling duct.

10. The ventilation system according to claim 9, wherein a ratio of the first airflow to the second airflow is 4:1.

11. The ventilation system according to claim 1, wherein the sensor device is configured to sense one or more environmental conditions, including but not limited to: smoke, gas, dust, temperature or humidity.

12. The ventilation system according to claim 1, wherein the ventilation system also includes a control system configured to control of the operation of the ventilation system in response to sensed environmental conditions.

13. The ventilation system according to claim 1, wherein the ventilation system also includes a communications subsystem for reporting to an external system any one or more of:
an environmental conditions sensed by the one or more sensor devices; and
an operating status of the exhaust fan.

14. The ventilation system according to claim 1, wherein the at least one sensor device includes means to block at least one of the ventilation air sampling port or the remote air sampling port to prevent the drawing of air through the blocked port.

15. The ventilation system according to claim 1, wherein the at least one sensor device includes a filter placed at a point between the detection chamber and one or more of the sampling ports for filtering unwanted particles from the air sample prior to analysis.

16. The ventilation system according to claim 1, wherein the ventilation system includes a flow impedance that determines what proportion of the air sample is drawn as a local air sample or a remote air sample.

17. The ventilation system according to claim 16, wherein the flow impedance is provided by an opening which has a predetermined flow resistance or a filter element having a predetermined flow resistance.
